(19) United States
(12) Patent Application Publication
(10) Pub. No.: US 2008/0150365 A1
(43) Pub. Date: Jun. 26, 2008

(54) MANUAL POWER SOURCE AND STORAGE FOR OPERATION OF ELECTRONIC DEVICES AND METHOD OF USE

(76) Inventor: John James Dougherty, Collegeville, PA (US)

Correspondence Address: GENERAL ELECTRIC CO.;GLOBAL PATENT OPERATION, 187 Danbury Road, Suite 204, Wilton, CT, 06897-4122, US

(21) Appl. No.: 11/614,440

(22) Filed: Dec. 21, 2006

(51) Int. Cl. H02J 9/00

(52) U.S. Cl. 307/68

(57) ABSTRACT

A manual power source to provide temporary power for the operation of an electronic device includes a manual power input unit; an electric power generator driven by the manual power input unit; a bridge rectifier and a voltage regulator coupled respectively in series to electric power generator; and an electric power storage unit coupled to the voltage regulator and to a power supply of the electronic device, the electric power storage unit being configured to be charged alternatively by a power supply of the electronic device and at least a portion of the electric power stored in the electric power storage unit being generated by the electric power generator driven by power input to the manual power input unit. A method of providing manually generated temporary power to drive an electronic device is also disclosed.

### BACKGROUND OF THE INVENTION

1. Field of the Invention

The present invention relates in general to electronic devices and, more particularly, to a temporary manual power source and storage for short-term operation of industrial electronic devices.

2. Description of the Related Art

Many electronic devices provide an unsafe situation for users when powered. For at least this reason, when users are required to make setting changes, power is first disconnected. However, in order to provide power for display and setting changes and to maintain power for real-time clocks when the main source of power is disconnected from the device, a battery is provided. Batteries are maintenance items, which may lose energy at unexpected times, may leak over an extended time of deployment, and may damage the product when they fail. In addition, replacement of batteries exposes the remainder of the product to ESD, or electrostatic discharge, risk and other inadvertent damage. Finally, batteries also pose a threat to the environment because these toxic items have to be disposed after use.

Although the use of temporary manual power sources is known, for example, in the cell phone market, some companies have created temporary manual battery charger, product operation still depends on the battery, which is temporally supported by the manual generator source. Therefore, a need exists for a manual power source that is integrated into the electronic device to provide operating power for a limited time or limited power for an extended period of time so as to eliminate the need for the provision of a battery and the elimination of the problems associated with the use of batteries, as just outlined.

### SUMMARY OF THE INVENTION

One or more of the above-summarized needs and others known in the art are addressed by temporary manual power sources to provide temporary power for operation of electronic devices, the power sources including a manual power input unit; a manually driven electric power generator; a bridge rectifier coupled to the electric power generator; a voltage regulator coupled to the bridge rectifier; and an electric power storage unit coupled to the voltage regulator and to a power supply of the electronic device.

In another aspects of the disclosed invention, electronic devices are disclosed that include a display; a microcomputer coupled to the display; a real-time clock and a switching circuit coupled at least to the microcomputer; a normal power supply to power the electronic device; and a temporary manual power source coupled to the switching circuit and the normal power supply, the temporary manual power source including a manual power input unit; a manually driven electric power generator; a bridge rectifier coupled to the electric power generator; a voltage regulator coupled to the bridge rectifier; and an electric power storage unit coupled to the voltage regulator and to a power supply of the electronic device, the electric power storage unit being configured to be charged by the power supply of the electronic device and at least a portion of an electric power stored in the electric power storage unit being generated by the electric power generator.

Methods of providing temporary power to drive electronic devices are also within the scope of the embodiments of the invention disclosed herein, such methods including the steps of manually driving an electric power generator to temporally generate electric power, the electric power generator being coupled sequentially to a bridge rectifier and a voltage regulator; charging an electric power storage unit coupled to an output of the voltage regulator with the power generated by the electric power generator, the electric power storage unit being coupled to a normal power supply of the electronic device and configured to be alternatively charged by the normal power supply; and supplying at least a portion of the temporally generated electric power stored in the electric power storage unit to drive the electronic device when the normal power supply is disconnected from a power source.

The above brief description sets forth rather features of the present invention in order that the detailed description that follows may be better understood, and in order that the present contributions to the art may be better appreciated. There are, of course, other features of the invention that will be described hereinafter and which will be for the subject matter of the appended claims.

In this respect, before explaining several preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a schematic of a temporary manual power source in accordance with aspects of the present technique;

FIG. 2 illustrates a schematic of another temporary manual power source in accordance with aspects of the present technique;

FIG. 3 illustrates an exemplary application of the temporary manual power source of FIG. 2; and

FIG. 4 illustrates a circuit diagram of an exemplary integration schematic of a temporary manual power source in accordance with aspects of the present technique.

### DETAILED DESCRIPTION OF THE PREFERRED EMBODIMENTS

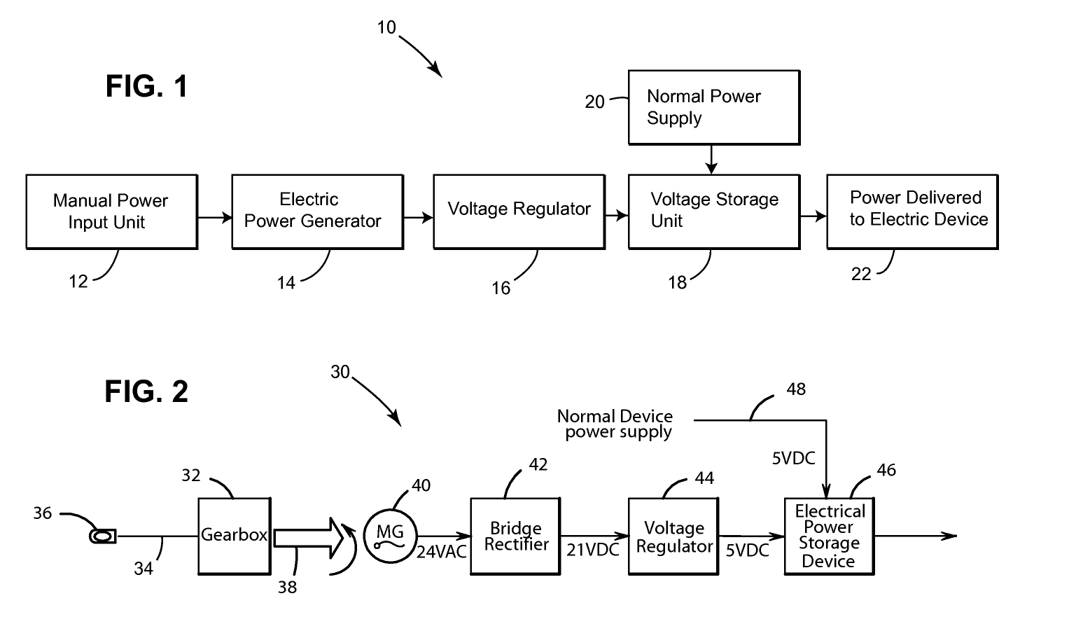

Referring now to the drawings, wherein like reference numerals designate identical or corresponding parts throughout the several views, several embodiments of the temporary manual power source of the invention will be described. Generally, as illustrated in FIG. 1, a temporary manual power source 10 includes a manually driven temporary electric power generator 14 driven by a manual input power unit 12 to generate electric power that is then regulated by a voltage regulator 16 and stored in a voltage storage unit 18. When the manually driven temporary electric power generator 14 is not activated by human power and the electronic device to which the temporary manual power source 10 is operating normally, a normal power supply 20 from the electronic device supplies the power to charge the voltage storage unit 18.

When the normal power source 20 is disconnected from the electronic device, power stored in the voltage storage unit 18 is temporally supplied to the electronic device for its full operation for a short amount of time or for its limited operation for an extended period of time at 22. If the voltage storage unit 18 is not fully charged or the power stored therein has been used, manual power is provided to the manual power input unit 12 to cause power to be generated by the manually driven electric power generator 14 to charge the voltage storage unit 18 and/or to provide power to drive the electronic device. Examples of such devices include, but are not limited to, a circuit breaker trip unit, protective relays, programmable logic controllers, industrial timers and industrial meters. As used herein, an electronic device is any device which employs electronic circuits and is provided with an external power supply that may be intentionally or unintentionally interrupted, thus requiring a separate batteryless source of power for either normal operation for a limited amount of time or reduced operation for an extended amount of time.

As such, embodiments of the disclosed invention provide for human power to be converted to electric power, which may be either used to temporarily power the electronic device or stored in a voltage storage unit and delivered to the connected product for a temporary or prolonged period of time, depending on the amount of power being consumed by the electronic device. Therefore, when the main source of power is disconnected from the electronic device, power is provided from a temporary manual power source in order to eliminate or minimize the need for a battery, thereby resolving many of the known problems associated with the use of a battery, such as, but not being limited to, needed maintenance, leakage, product damage associated with battery failure, and environmental threat related to used battery disposal.

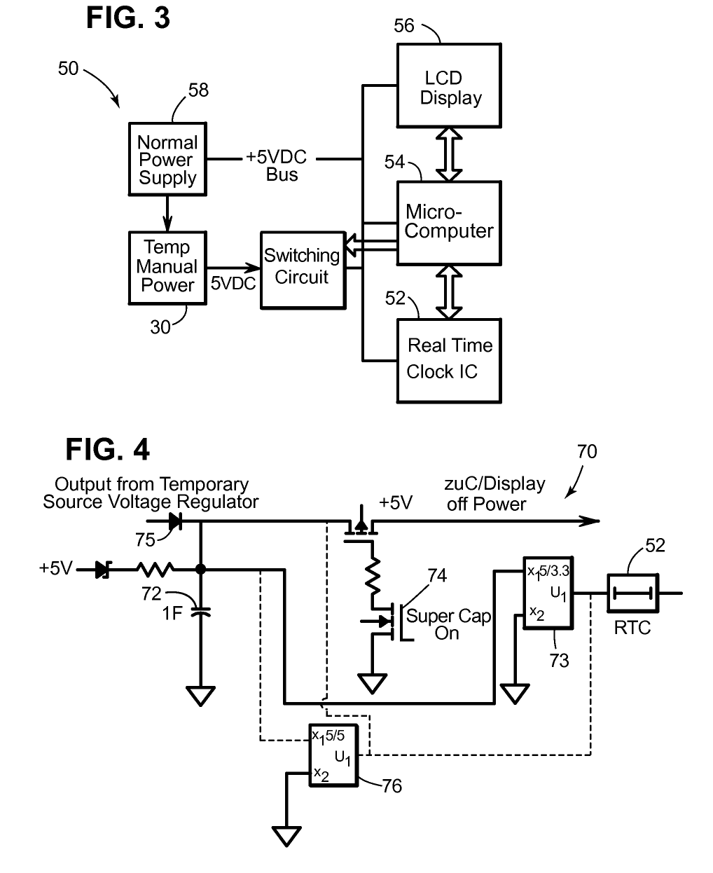

In another exemplary embodiment of the invention disclosed, FIG. 2 shows a basic block diagram of another temporary power source 30 according to the subject matter disclosed herein. FIG. 3 is a block diagram 50 illustrating the integration of yet another manual power source of the invention into an electronic device. And FIG. 4 shows an exemplary circuit integration diagram 70 of the temporary manual power source.

As shown in FIG. 2, the temporary power source 30 includes a gearbox 32 having a pulley/gearbox combination (not shown) driven by a pull cord 34 having a handle 36 connected to the end thereof. The gearbox 32 is configured to convert the linear force and motion that a user creates by pulling on the handle 36 of the pull cord 34 into a rotary motion. The rotary shaft 38 out of the gearbox 32 is connected to an electric power generator 40, which converts the rotary motion of the rotating shaft 38 to electrical power supplied to a bridge rectifier 42. Although many types of electric power generator 40 may be used, the electric power generator 40 preferably employs permanent magnets for increased efficiency.

As illustrated in FIG. 2, in the embodiment of the temporary power source 30, the output power from the electric power generator 40 is 24-volt AC. As understood by those of ordinary skill in the applicable arts, the power level out of the electric power generator 40 may vary according to the rate and repetitions that the user applies to the pull cord 34. For example, in one embodiment, a 60-cm pull of the pull cord 34 at a repetition rate of 40 pulls per minute will deliver 2.5 A at a level of 24-volt AC. The AC power thus created is then applied to a bridge rectifier 42 for conversion into DC power. The resulting 21-volt DC power output is subsequently applied to a voltage regulator 44, which converts the 21-volt DC output from the bridge rectifier 42 to 5.0-volt DC.

The output of the voltage regulator 44 is then applied to an electric power storage device 46. As understood by those of ordinary skill in the art, several different devices exist that are capable of storing the power supplied from the voltage regulator 44. For example, a large capacitor, which retains an electric charge until a current discharge path is provided, may be used as the electric power storage device 46, such capacitors being capable of providing as much as 1 F of capacitance. Depending on the circuit to be temporarily supplied with power, such a capacitor can supply operating current for a time ranging from a minute (full product operation) to several weeks (real-time clock). As illustrated, the electrical power storage device 46 may be charged from two different sources. The first is the power supply inherent to the product (a trickle charge illustrated as a 5-volt DC power input 48) and the second is the power supplied from the temporary power source 30.

For many low power devices, such as for example, but not a limitation, circuit breaker trip units, the energy required to charge the electric power storage device 46 might not be available quickly. Circuit breaker trip units draw power from the current passing through the circuit breaker. When the trip unit operates to ‘trip’ the breaker, current flow in the breaker stops and the power from the current sensor ceases. Most electronic trip units to not have alternative sources of power other than a battery. When the circuit breaker trip unit operates, it is very useful to interrogate the trip unit for the cause of the trip prior to resetting the breaker. If the trip unit has no battery or a failed or discharged battery, a user may reset the circuit breaker with dangerous faults on the line. In these situations, the temporary power source 30 can provide the power quickly and the user can quickly replenish the source if longer periods of temporary operation are required. As understood by one skilled in the art, several embodiments of rectification, voltage regulation, and voltage reduction devices may be applied to the output of the electric power generator 40. Different AC or DC voltage outputs are also within the scope of the disclosed inventions. Similarly, while the illustrated embodiment shows the pull cord 34 to convert manual power to rotary power to drive the electric power generator 40, other manual input approaches may also be employed, including, but not being limited to, a thumbwheel, a ratchet handle, a foot pedal, and a rotary crank mechanism, to name a few. In addition, the illustrated embodiment shows the electric power generator 40 being a rotary shaft generator/alternator; however, other generator configurations, such as, for example, but as a limitation, linear generator/alternators would be equally applicable. Finally, the illustrated embodiment shows an electrical capacitance as the method of energy storage; however, other methods of temporary storage, including, but not being limited to mechanical devices (e.g., a flywheel), chemical devices (e.g., sealed, maintenance-free battery technology) or a magnetic storage device would be within the scope of the disclosed embodiments of the invention for conversion of manual power to electrical power for short-term operation of an electronic device.

Turning to FIG. 3, a block diagram 50 for an embodiment of the temporary power source 30 of the invention is illustrated integrated with an electronic device. In the illustrated embodiment, the temporary power source 30 is designed to provide two functions, i.e. the long-term operation of a real-time clock 42 (e.g., for a period of one week or longer) and/or the temporary operation of a microcomputer 54 and display 56 during power outages for a short period of time. In normal operation, power supplied to the unit from a utility source or another external source 58 operates the device and charges the electric storage device 46 of the temporary power source 30, as already explained. When power is lost, the very low power drain of the real-time clock 52 can maintain operation of that element for several weeks on a fully charged electrical storage device 46. When power is lost or removed and the user wishes to operate the electronic device, the user operates the temporary power source 30 by pulling on the pull cord 34 several times to charge the electrical power storage device 46 to a full power. The microcomputer and display, in this embodiment, receive power until the electrical storage device 46 discharges to a set level. This level is set to ensure that the real-time clock 52 will continue to operate for a specified time (e.g., 12 hours). In one particular embodiment, a press key (not shown) may be provided to start the process of supplying power from the storage unit to the electronic device. The display 56 will flash or otherwise signal the user that the temporary charge has been dissipated to a minimum level to operate the real-time clock 52 and the user can either operate the pull cord again or conclude operation of the device. If the user does not press the key within a pre-determined amount of time, e.g., a 20-second period, the device will also deenergize to retain as much charge as possible in the electrical storage device 46 for backup of the real-time clock 52.

A schematic of an integration circuit 70 of the normal power supply 58 (+5V ) of the electronic device with the electric storage device 46 (illustrated as a super capacitor 72) of the temporary power source 30 is illustrated in FIG. 4. As shown, the output of the super capacitor 72 always supplied power to the real-time clock 52 through a 5V to 3.3V DC to DC regulator 73. During normal operation, the power for the real-time clock 52 comes from the normal power supply, which also trickle charges the super capacitor 72. In the embodiment illustrated in FIG. 4, the regulator 73 supplies 3.3 V to the real-time clock 52, which can be operated with a power supply as low as 1.3 V. When normal power is lost, the super capacitor 72 can supply the real-time clock 52 for up to 3 weeks. When a user chooses to operate the electronic device without the main power, the temporary power source is operated via the pull cord 34. The temporary power source charges the super capacitor 72 via a rectifier 75. When the super capacitor 72 is charged to +5V, a bootstrap circuit (not shown) will temporarily operate the MOSFET 74 and turn on the P channel MOSFET to supply power from the super capacitor 72 to the microcomputer 54 (not shown in FIG. 4). The microcomputer will startup and provide ongoing power to the MOSFET to keep itself on. The microcomputer 54 monitors the available voltage from the super capacitor. If the voltage drops below 3.3 V, the user is warned, then the microcomputer 54 removes power from the MOSFET circuit 74 which in turn removes power from the microcomputer 54 and display 56 (also not shown in FIG. 4). In one embodiment, if the user does not press the key for a predetermined amount of time, e.g., 20 seconds, the microcomputer 54 and display 56 de-energize, thus allowing the voltage on the fully charged super capacitor 72 to drop from 5 V to 3.3 V and provide up to 1 minute of operation. There is still sufficient charge to maintain the real-time clock 52 for a week or more. Any time the user operates the temporary power source 30, the super capacitor 72 is recharged and a new 20-second period is started (like when the key is pressed). In an alternative embodiment, shown on FIG. 4 by the dotted lines, an efficient 5 V to 5 V DC-DC converter 76 maintains 5-volt output for voltages on the super capacitor 72 down to 3.3 V. This approach allows the microcomputer 54 and display 56 to operate at a full 5 V if needed.

Conventionally, the primary way for supplying the function described in this disclosure is the inclusion of a battery. In some electronic devices, a handheld unit with a main-powered or battery-powered supply has been used via an external connector to operate the device. Other electronic devices have employed the use of a super capacitor to maintain real-time clock operation, but not in conjunction with a manual source for full device operation. A ready-to-use power source is disclosed for electronic devices any time that power is not available. Examples of power unavailable times include, but are not limited to, when there is a power outage, when the device is de-energized for safety reasons, and when the electronic device is not installed in the basic equipment where it belongs. The temporary power sources of the invention provide the ability to test the device on a bench, during outages and in safety situations. The temporary power source is permanent. It does not need to be brought to the device installation. It does not have maintenance required associated with batteries that must be removed.

Methods of providing temporary power to drive electronic devices are also within the scope of the disclosed embodiments of the invention disclosed herein. Such methods include the steps of manually driving an electric power generator to temporally generate electric power, the electric power generator being connected sequentially to a bridge rectifier and a voltage regulator; charging an electric power storage unit connected to an output of the voltage regulator with the power generated by the electric power generator, the electric power storage unit being connected to a normal power supply of the electronic device, and the electric power storage unit being configured to be alternatively charged by the normal power supply; and supplying at least a portion of the temporally generated electric power stored in the electric power storage unit to drive the electronic device when the normal power supply is disconnected from a power source. In such methods, the manually driving may further include pulling a cord connected to a gearbox having an input connected to the pull cord, and an output shaft connected between an output of the gearbox and the electric power generator, the gearbox being configured to convert a linear force manually applied to the pull cord into a rotary motion of the output shaft. In one embodiment of the disclosed methods, the electric power storage unit is a super capacitor and the temporally generated electric power is sufficient to drive the electronic device during a first time period of normal level of operation and a second time period of reduced level of operation, the first time period being shorter than the second time period.

With respect to the above description, it should be realized that the optimum dimensional relationships for the parts of the invention, to include variations in size, form function and manner of operation, assembly and use, are deemed readily apparent and obvious to those skilled in the art, and therefore, all relationships equivalent to those illustrated in the drawings and described in the specification are intended to be encompassed only by the scope of appended claims.

In addition, while the present invention has been shown in the drawings and fully described above with particularity and detail in connection with what is presently deemed to be practical and several of the preferred embodiments of the invention, it will be apparent to those of ordinary skill in the art that many modifications thereof may be made without departing from the principles and concepts set forth herein. Hence, the proper scope of the present invention should be determined only by the broadest interpretation of the appended claims so as to encompass all such modifications and equivalents.

What is claimed is:

1. A temporary manual power source apparatus configured to provide temporary power for operation of an electronic device, the apparatus comprising:
a manual power input unit;
an electric power generator driven by the manual power input unit;
a bridge rectifier coupled to an electric power output of the electric power generator;
a voltage regulator coupled to an electric power output of the bridge rectifier; and
an electric power storage unit coupled to an electric power output of the voltage regulator and to a power supply of the electronic device.

2. The apparatus of claim 1, wherein the manual power input unit comprises a pull cord, a gearbox having an input coupled to the pull cord, and an output shaft coupled between an output of the gearbox and the electric power generator, the gearbox being configured to convert a linear force manually applied to the pull cord into a rotary motion of the output shaft.

3. The apparatus of claim 1, wherein the electronic device is selected from the groups consisting of a circuit breaker trip unit, a protective relay, a programmable logic controller, an industrial timer, and an industrial meter.

4. The apparatus of claim 1, wherein the manual power input unit comprises a manual power input, a gearbox having an input connected to the manual power input, and an output shaft connected between an output of the gearbox and the electric power generator, the manual power input unit is selected from the group consisting of a thumbwheel, a ratchet handle, a foot pedal, and a rotary crank mechanism, and the gearbox is configured to convert a force manually applied to the manual power input into a rotary motion of the output shaft.

5. The apparatus of claim 1, wherein the electric power generator is a rotary shaft or a linear generator/alternator.

6. The apparatus of claim 1, wherein the electric storage unit is configured to be charged by the power supply of the electronic device and at least a portion of an electric power stored in the electric power storage unit is generated by the electric power generator driven by power input to the manual power input unit.

7. The apparatus of claim 1, wherein the electric power storage unit is selected from the group consisting of a capacitor, a flywheel, a sealed maintenance-free battery, a magnetic device, and a combination thereof.

8. The apparatus of claim 1, wherein the portion of the electric power stored in the electric power storage unit is sufficient to drive the electronic device during a first time period of normal operation and a second time period of reduced operation, the first time period being shorter than the second time period.

9. The apparatus of claim 8, wherein the reduced operation comprises an operation of a real-time clock of the electronic device.

10. The apparatus of claim 1, wherein the electric power generator comprises permanent magnets.

11. An electronic device, comprising:
a display;
a microcomputer coupled to the display via a bus;
a real-time clock coupled to the microcomputer via the bus;
a switching circuit coupled to the bus;
a normal power supply coupled to the bus; and
a temporary manual power source coupled to the switching circuit and the normal power supply, the temporary manual power source being configured to provide temporary power for operation of the electronic device, the temporary manual power source comprising
a manual power input unit,
an electric power generator driven by the manual power input unit,
a bridge rectifier coupled to an electric power output of the electric power generator,
a voltage regulator coupled to an electric power output of the bridge rectifier, and
an electric power storage unit coupled to an electric power output of the regulator and to the normal power supply of the electronic device.

12. The electronic device of claim 11, wherein the electric power storage unit is configured to be charged by the normal power supply of the electronic device and at least a portion of an electric power stored in the electric power storage unit is generated by the electric power generator driven by power input to the manual power input unit.

13. The electronic device of claim 11, wherein the manual power input unit comprises a pull cord, a gearbox having an input coupled to the pull cord, and an output shaft coupled between an output of the gearbox and the electric power generator, the gearbox being configured to convert a linear force manually applied to the pull cord into a rotary motion of the output shaft.

14. The electronic device of claim 11, wherein the electric power generator is a rotary shaft or a linear generator/alternator.

15. The electronic device of claim 11, wherein the electric power storage unit a super capacitor.

16. The electronic device of claim 11, wherein the portion of the electric power stored in the electric power storage unit is sufficient to drive the electronic device during a first time period of normal level of operation and a second time period of reduced level of operation, the first time period being shorter than the second time period.

17. A method of providing temporary power to drive an electronic device, the method comprising:
manually driving an electric power generator to temporally generate electric power, the electric power generator being connected sequentially to a bridge rectifier and a voltage regulator;
charging an electric power storage unit coupled to an output of the voltage regulator with the power generated by the electric power generator, the electric power storage unit being coupled to a normal power supply of the electronic device, and the electric power storage unit being configured to be alternatively charged by the normal power supply; and
supplying at least a portion of the temporally generated electric power stored in the electric power storage unit to drive the electronic device when the normal power supply is disconnected from a power source.

18. The method of claim 17, wherein manually driving further comprises pulling a cord connected to a gearbox having an input coupled to the pull cord, and an output shaft coupled between an output of the gearbox and the electric power generator, the gearbox being configured to convert a linear force manually applied to the pull cord into a rotary motion of the output shaft.

19. The method of claim 17, wherein the electric power storage unit is a super capacitor.

20. The method of claim 17, wherein the temporally generated electric power is sufficient to drive the electronic device during a first time period of normal level of operation and a second time period of reduced level of operation, the first time period being shorter than the second time period.
